(19) United States
(12) Patent Application Publication
(10) Pub. No.: US 2012/0301389 A1
(43) Pub. Date: Nov. 29, 2012

(54) METHOD FOR THE SEPARATION OF A NON-VOLATILE STRONG ACID FROM A SALT THEREOF AND COMPOSITIONS PRODUCED THEREBY

(75) Inventors: Aharon Eyal, Jerusalem (IL); Asher Vitner, Jerusalem (IL); Revital Mali, Jerusalem (IL); Carmi Raz, Gizo (IL)

(73) Assignees: ASHER VITNER LTD., Jerusalem (IL); EYAL RESEARCH CONSULTANTS LTD., Jerusalem (IL)

(21) Appl. No.: 13/574,641

(22) PCT Filed: Feb. 6, 2011
(86) PCT No.: PCT/IL11/00132

§ 371 Date: Jul. 23, 2012

Related U.S. Application Data
(60) Provisional application No. 61/302,116, filed on Feb. 6, 2010.

(30) Foreign Application Priority Data
Feb. 3, 2011 (IL) 211/043

(51) Int. Cl. C01B 17/90; C09K 3/00

(52) U.S. Cl. 423/531; 252/364

(57) ABSTRACT

The present invention provides an organic phase composition comprising
(a) a first solvent (S1) characterized by water solubility of less than 10% and by at least one of (a1) having a polarity related component of Hoy's cohesion parameter (delta-P) between 5 and 10 MPa^{1/2} and (b1) having a Hydrogen bonding related component of Hoy's cohesion parameter (delta-H) between 5 and 20 MPa^{1/2};
(b) a second solvent (S2) characterized by a water solubility of at least 30% and by at least one of (a2) having delta-P greater than 8 MPa^{1/2} and (b2) having delta-H greater than 12 MPa^{1/2};
(c) water;
(d) a non-volatile strong acid; and
(e) a salt thereof.

The present invention relates to a novel method for the separation of a non-volatile strong acid from a salt thereof and to an organic phase composition produced thereby.

### SUMMARY OF THE INVENTION

The present invention provides, according to a first aspect, an organic phase composition comprising: (a) a first solvent (S1) characterized by a water solubility of less than 10% and by at least one of (a1) having a polarity related component of Hoy's cohesion parameter (delta-P) between 5 and 10 MPa^{1/2} and (b1) having a hydrogen bonding related component of Hoy's cohesion parameter (delta-H) between 5 and 20 MPa^{1/2}; (b) a second solvent (S2) characterized by a water solubility of at least 30% and by at least one of (a2) having a delta-P greater than 8 MPa^{1/2} and (b2) having a delta-H greater than 12 MPa^{1/2}; (c) water, (d) acid, and (e) a salt thereof.

According to various embodiments, S2 is selected from the group consisting of C1-C4 mono- or poly-alcohols, aldehydes and ketones and S1 is selected from the group consisting of alcohols, ketones and aldehydes having at least 5 carbon atoms.

According to an embodiment the non-volatile strong acid is selected from the group consisting of sulfuric acid, phosphoric acid and nitric acid.

According to an embodiment, said salt is selected from the group consisting of salts of calcium and of heavy metals.

According to various embodiments, the weight/weight ratio of S1/S2 is in the range between 10 and 0.5; the weight/weight ratio of acid/water is greater than 0.15, the weight/weight ratio of acid/salt is greater than 5 and/or the salt concentration is in a range between 0.01% wt and 5% wt.

According to various embodiments S1 forms a heterogeneous azeotrope with water, and/or S2 forms a homogeneous azeotrope with water.

The present invention provides according to a second aspect a method for the separation of a non-volatile strong acid from a salt comprising: (i) providing an aqueous feed solution comprising a non-volatile strong acid and a salt; (ii) bringing said aqueous feed solution into contact with a first extractant comprising a first solvent (S1) characterized by a water solubility of less than 10% and by at least one of (a1) having a delta-P between 5 and 10 MPa^{1/2} and (b1) having a delta-H between 5 and 20 MPa^{1/2}, whereupon said acid selectively transfers to said first extractant to form an acid-carrying first extract and an acid-depleted aqueous feed; (iii) bringing said acid-depleted aqueous feed solution into contact with a second extractant comprising S1 and a second solvent (S2) characterized by a water solubility of at least 30% and by at least one of (a2) having a delta-P greater than 8 MPa^{1/2} and (b2) having a delta-H greater than 12 MPa^{1/2}, whereupon said acid selectively transfers to said second extractant to form an organic phase composition according to the first aspect and a further acid-depleted aqueous feed; and (iv) recovering acid from said first extract.

According to an embodiment, said aqueous feed is a product of leaching a mineral with a non-volatile strong acid. According to another embodiment, said mineral is rich in titanium. According to another embodiment, said mineral is rich in phosphate

According to an embodiment, at least one of said bringing in contact of step (ii) and said bringing in contact of step (iii) comprises multiple stage counter-current contacting.

According to an embodiment, the delta-P of said second extractant is greater than the delta-P of said first extractant by at least 0.2 MPa^{1/2}. According to another embodiment, the delta-H of said second extractant is greater than the delta-H of said second extractant by at least 0.2 MPa^{1/2}.

According to an embodiment the first extractant comprises S2 and the S2/S1 ratio in the second extractant is greater than the S2/S1 ratio in the first extractant by at least 10%. According to a related embodiment, the first extractant is generated from the organic phase composition formed in step (iii) by removing S2 therefrom.

According to an embodiment, the method comprises a step of removing S2 from the organic phase composition formed in step (iii), whereupon said first extract is formed. According to a related embodiment, upon said removing of S2, a heavy aqueous phase is formed and said heavy phase is separated from said formed first extract. According to related embodiments, the acid/water ratio in said heavy phase is smaller than that ratio in the acid-depleted aqueous feed and/or the acid/salt ratio in the heavy phase is smaller than that ratio in the acid-depleted aqueous feed.

According to various embodiments, the acid/water ratio in the first extract is greater than that ratio in the organic phase composition of step (iii) by at least 10%; the acid/water ratio in the first extract is greater than that ratio in the aqueous feed by at least 10% and/or the acid/salt ratio in said first extract is greater than that ratio in the organic phase composition of step (iii) by at least 10%.

According to an embodiment, recovering comprises at least one of acid back-extraction with water or with an aqueous solution, removal of S1, S2 or both and addition of a solvent S3, which solvent is characterized by water solubility smaller than that of S1.

According to another embodiment, said non-volatile strong acid is sulfuric acid and said step of acid recovery comprises contacting said first extract with sulfur trioxide.

According to another embodiment, the Acid/salt ratio in the further depleted aqueous feed is smaller than 0.05.

According to still another embodiment, the provided aqueous feed comprises an impurity, the impurity/salt ratio in said feed is R1, the impurity/salt ratio in the further depleted aqueous feed is R2 and the ratio of R1 to R2 is greater than 1.5. According to an embodiment, said impurity is another acid. According to another embodiment, said impurity is another salt.

### DETAILED DESCRIPTION OF THE INVENTION

The present invention provides, according to an aspect, a method for the separation of a non-volatile strong acid from a salt thereof comprising: (i) providing an aqueous feed solution comprising a non-volatile strong acid and a salt thereof; (ii) bringing said aqueous feed solution into contact with a first extractant comprising a first solvent (S1) characterized by a water solubility of less than 10% and by at least one of (a1) having delta-P between 5 and 10 MPa^{1/2} and (b1) having delta-H between 5 and 20 MPa^{1/2}, whereupon acid selectively transfers to said first extractant to form an acid-carrying first extract and an acid-depleted aqueous feed; (iii) bringing said acid-depleted aqueous feed solution into contact with a second extractant comprising S1 and a second solvent (S2) characterized by a water solubility of at least 30% and by at least one of (a2) having a delta-P greater than 8 MPa^{1/2} and (b2) having a delta-H greater than 12 MPa^{1/2}, whereupon acid selectively transfers to said second extractant to form an organic phase composition according to the first aspect and a further acid-depleted aqueous feed; and (iv) recovering acid from said first extract.

The invention will now be described in connection with certain preferred embodiments with reference to the following illustrative FIGURE so that it may be more fully understood.

With specific reference now to the FIGURE in detail, it is stressed that the particulars shown are by way of example and for purposes of illustrative discussion of the preferred embodiments of the present invention only and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the Drawings:

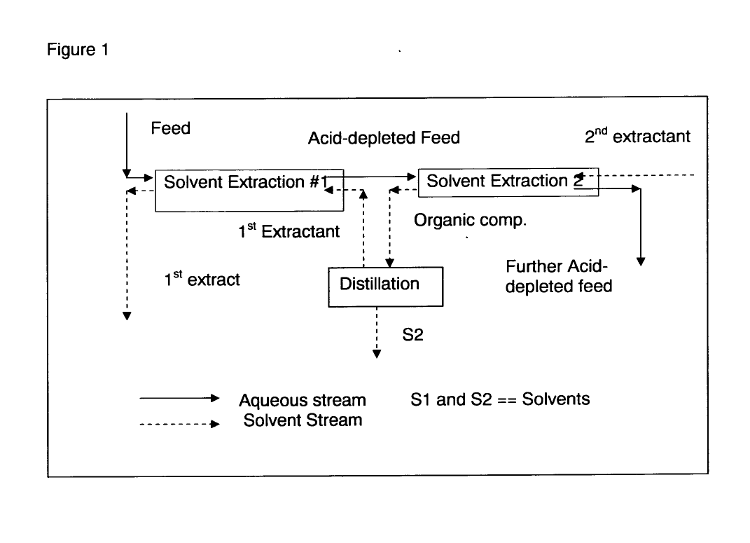

FIG. 1 is a schematic flow plan of a process according to the present invention.

The feed to the process is an aqueous solution comprising a non-volatile strong acid and a salt of said acid. According to an embodiment, the non-volatile strong acid is selected from the group consisting of sulfuric acid, phosphoric acid and nitric acid. According to a preferred embodiment, said non-volatile strong acid is sulfuric acid.

According to an embodiment, said aqueous feed is a product of leaching a mineral with the non-volatile strong acid. According to another embodiment, said mineral is rich in titanium. According to another embodiment said mineral is rich in phosphate. According to an embodiment, the feed to the process is a product of reacting a phosphate rock with hydrochloric acid to form CaCl₂ and phosphoric acid. Preferably, leaching is in a highly concentrated acid solution, forming an aqueous solution leachate containing the non-volatile strong acid and its salts or salts of another acid and optionally an insoluble fraction. Such insoluble fraction is separated and the leachate is used as the aqueous feed as such, or after some modification. According to an embodiment, modification may include a purification step. According to an embodiment, the salt is selected from the group consisting of salts of calcium and of heavy metals. According to a preferred embodiment, said heavy metal is titanium.

Unless specified otherwise, the term “acid” as used herein means a non-volatile strong acid. Unless specified otherwise, the term “salt” as used herein means a salt of the acid or of another acid.

According to the method of the invention, the feed is brought into contact with a first extractant comprising a first solvent (S1). The solubility of S1 in water at 25° C. is less than 10%, preferably less than 5%, more preferably less than 2% and most preferably less than 1%. S1 is further characterized and by at least one of (a1) having a delta-P between 5 and 10 MPa^{1/2}, preferably between 6 and 9 MPa^{1/2} and more preferably between 6.5 and 8.5 MPa^{1/2} and (b1) having a delta-H between 5 and 20 MPa^{1/2}, preferably between 6 and 16 MPa^{1/2} and more preferably between 8 and 14 MPa^{1/2}. Delta-P is the polarity related component of Hoy's cohesion parameter and delta-His the hydrogen bonding related component of Hoy's cohesion parameter. According to an embodiment, the boiling point of S1 is greater than that of water, preferably greater than 120° C. at atmospheric pressure, more preferably greater than 140° C., and most preferably greater than 160° C. According to another embodiment the boiling point of S1 is lower than 250° C. at atmospheric pressure, more preferably lower than 220° C., and most preferably lower than 200° C. According to another embodiment, S1 forms a heterogeneous azeotrope with water. According to an embodiment, the boiling point of that heterogeneous azeotrope is less than 100° C. at atmospheric pressure.

According to an embodiment, S1 forms at least 60% of the first extractant, preferably at least 80% and more preferably at least 90%. According to a preferred embodiment S1 is the sole solvent in the first extractant. According to an embodiment, the first extractant also comprises water.

The cohesion parameter, or, solubility parameter, was defined by Hildebrand as the square root of the cohesive energy density:

$$δ = \sqrt{\frac{Δ {E}_{vap}}{V}}$$

where ΔEvap and V are the energy or heat of vaporization and molar volume of the liquid, respectively. Hansen extended the original Hildebrand parameter to three-dimensional cohesion parameter. According to this concept, the total solubility parameter delta is separated into three different components, or, partial solubility parameters relating to the specific intermolecular interactions:

δ²=δ_{d}²+δₚ²+δₕ²

in which delta-D, delta-P and delta-H are the dispersion, polarity, and Hydrogen bonding components, respectively. Hoy proposed a system to estimate total and partial solubility parameters. The unit used for those parameters is MPa^{1/2}. A detailed explanation of that parameter and its components could be found in “CRC Handbook of Solubility Parameters and Other Cohesion Parameters”, second edition, pages 122-138. That and other references provide tables with the parameters for many compounds. In addition, methods for calculating those parameters are provided.

In the scheme of the FIGURE, the aqueous feed and the first extractant are brought in contact in the operation marked Solvent Extraction #1. According to an embodiment, contacting consists of multiple-stage counter-current operation conducted in commercial liquid-liquid contactors, e.g. mixers-settlers or pulsating columns.

Contacting results in selective transfer of acid from the feed to the first extractant to form an acid-carrying first extract and an acid-depleted aqueous feed, which are then separated. Selective transfer of acid, as used here, means that, on a solvent-free basis, acid concentration in the first extract is greater than acid concentration in the feed. According to an embodiment, a salt also transfers from the feed to the first extractant, but the acid/salt ratio in the first extract is greater than that ratio in the aqueous feed by at least 2 times, preferably by at least 5 times and more preferably by at least 10 times. According to another embodiment, water also transfer from the feed to the first extractant, but the acid/water ratio in the first extract is greater than that ratio in the aqueous feed by at least 10%, preferably by at least 30%, more preferably by at least 60% and most preferably by at least 100%.

According to the method of the invention the separated acid-depleted aqueous feed solution is brought into contact with a second extractant comprising S1 (the same solvent as in the first extractant) and a second solvent (S2). The solubility of S1 in water at 25° C. is greater than 30%, preferably greater than 50%, more preferably greater than 60% and most preferably S2 is fully miscible with water. S2 is further characterized and by at least one of (a2) having a delta-P greater than 8 MPa^{1/2}, preferably greater than 10 MPa^{1/2} and more preferably greater than 12 MPa^{1/2} and (b1) having a delta-H greater than 12 MPa^{1/2}, preferably greater than 14 MPa^{1/2} and more preferably greater than 16 MPa^{1/2}. According to an embodiment, the boiling point of S2 is smaller than that of water, preferably smaller than 90° C. at atmospheric pressure, more preferably smaller than 80° C., and most preferably smaller than 75° C. According to another embodiment the boiling point of S2 is greater than 20° C. at atmospheric pressure. According to another embodiment, S2 forms a homogeneous azeotrope with water.

According to an embodiment, a mixture of S1 and S2 forms at least 60% of the second extractant, preferably at least 80% and more preferably at least 90%. According to a preferred embodiment S1 and S2 are the only solvents in the second extractant. According to an embodiment, the second extractant also comprises water. According to an embodiment, the method further comprises the step of forming the second extractant and said forming comprises combining the first solvent formed in said recovering of the acid in step (iv) with S2.

In the scheme of the FIGURE, the acid-depleted aqueous feed and the second extractant are brought in contact in the operation marked Solvent Extraction #2. According to an embodiment, contacting consists of a multiple-stage counter-current operation conducted in commercial liquid-liquid contactors, e.g. mixers-settlers or pulsating columns. Upon contacting, acid transfers selectively to the second extractant to form an organic phase composition according to the first aspect and a further acid-depleted aqueous feed, which, according to an embodiment, are separated. Thus, on a solvent free basis, acid concentration in the organic phase composition is greater than acid concentration in the acid-depleted aqueous feed.

The formed further acid-depleted aqueous feed is a de-acidified salt solution suitable for use as such or after further treatment, e.g. further purification, electrowinning, hydrolysis, etc. According to an embodiment, the acid/salt ratio in that further acid-depleted aqueous feed is less than 0.05, preferably less than 0.03, more preferably less than 0.02 and most preferably less than 0.01.

The present invention also provides an organic phase composition comprising: (a) a first solvent (S1) characterized by a water solubility of less than 10% and by at least one of (a1) having a polarity related component of Hoy's cohesion parameter (delta-P) between 5 and 10 MPa^{1/2} and (b1) having a hydrogen bonding related component of Hoy's cohesion parameter (delta-H) between 5 and 20 MPa^{1/2}; (b) a second solvent (S2) characterized by a water solubility of at least 30% and by at least one of (a2) having a delta-P greater than 8 MPa^{1/2} and (b2) having a delta-H greater than 12 MPa^{1/2}; (c) water, (d) a non-volatile strong acid, and (e) a salt thereof.

According to various embodiments, S2 is selected from the group consisting of C1-C4 mono- or poly-alcohols, aldehydes and ketones and S1 is selected from the group consisting of alcohols, ketones and aldehydes having at least 5 carbon atoms.

According to an embodiment, said salt is selected from the group consisting of salts of calcium and of heavy metals. According to an embodiment, the salt is titanium sulfate.

According to an embodiment, the organic phase composition is formed in said contacting of the acid-depleted aqueous feed with the second extractant, the first solvent (S1) is the first solvent of the first and second extractant, the second solvent (S2) is the second solvent of the second extractant and the acid, the water and the salt are extracted from the acid-depleted aqueous feed.

According to an embodiment S1 is selected from the group consisting of alcohols, ketones and aldehydes having at least 5 carbon atoms, e.g. n-butanol, various pentanols, hexanols, heptanols, octanols, nonanols, decanols, methyl-isobutyl-ketone and methyl-butyl-ketone.

According to an embodiment, S2 is selected from the group consisting of C1-C4 mono- or poly-alcohols, aldehydes and ketones, e.g. methanol, ethanol, propanol, iso-propanol, tert-butanol, ethylene glycol and acetone.

According to various embodiments, the weight/weight ratio of S1/S2 in the organic phase composition is in the range between 10 and 0.5, preferably between 1 and 9 and more preferably between 2 and 8.

According to another embodiment, the weight/weight ratio of acid/water in the organic phase composition is greater than 0.15, preferably greater than 0.20 and more preferably greater than 0.25.

According to another embodiment the weight/weight ratio of acid/salt in the organic phase composition is greater than 5, preferably greater than 10 and more preferably greater than 15.

According to another embodiment the salt concentration in the organic phase composition is in a range between 0.01% wt and 5% wt, preferably between 0.02% wt and 4% wt and more preferably between 0.03% wt and 3% wt.

According to an embodiment, S1 forms a heterogeneous azeotrope with water. According to another embodiment S2 forms a homogeneous azeotrope with water.

According to an embodiment, the first extractant is formed from the organic phase composition. Thus, according to an embodiment, the method comprises a step of removing S2 from the organic phase composition, whereupon the first extract is formed. Any method of removing S2 is suitable. According to a preferred embodiment, S2 is removed by distillation. According to alternative embodiments, S2 is fully removed or only partially removed. According to an embodiment, both S2 and water are removed from the organic phase composition in order to form the first extractant.

According to an embodiment, upon said removing of S2, a heavy aqueous phase is formed and said heavy phase is separated from said formed first extract. According to an embodiment, the acid/water ratio in the heavy phase is smaller than that ratio in the acid-depleted aqueous feed. According to another embodiment the acid/salt ratio in the heavy phase is smaller than that ratio in the acid-depleted aqueous feed. According to an embodiment, said heavy phase is combined with at least one of the aqueous feed, with the acid-depleted aqueous feed, with an intermediate step of their extraction with the first extractant and with an intermediate step of their extraction with the second extractant.

As further explained in the literature, delta-P and delta-H could be assigned to single components as well as to their mixtures. In most cases, the values for the mixtures could be calculated from those of the single components and their proportions in the mixtures. According to a preferred embodiment, the second extractant is more hydrophilic than the first one. According to an embodiment, S1 is the main or sole component of the first extractant. According to another embodiment, a mixture of S1 and S2 forms the main or sole component of the second extractant. S2 is more hydrophilic (has higher polarity and/or higher capacity of forming hydrogen bonds) than S1. Thus, preferably, the second extractant is more hydrophilic than the first one. According to an embodiment, the delta-P of the second extractant is greater than the delta-P of said first extractant by at least 0.2 MPa^{1/2}, preferably at least 0.4 MPa^{1/2} and more preferably at least 0.6 MPa^{1/2}. According to another embodiment, the delta-H of the second extractant is greater than the delta-H of said second extractant by at least 0.2 MPa^{1/2}, preferably by at least 0.4 MPa^{1/2} and more preferably by at least 0.6 MPa^{1/2}. According to still another embodiment, both the delta-P and the delta-H of the second extractant are greater than those of the second extractant by at least 0.2 MPa^{1/2}, preferably by at least 0.4 MPa^{1/2} and more preferably by at least 0.6 MPa^{1/2}.

According to an embodiment both extractants comprises S1 and S2 and the S2/S1 ratio in the second extractant is greater than the S2/S1 ratio in the first extractant by at least 10%, preferably at least 30%, more preferably that ratio in the second extractant is at least 2 times greater than that in the first and most preferably at least 5 times.

According to a preferred embodiment of the invention, the first extractant is more selective with regards to acid extraction than the second extractant. Selectivity to acid over water (S_{A/W}) can be determined by equilibrating an aqueous acid solution with an extractant and analyzing the concentrations of the acid and the water in the equilibrated phases. In that case, the selectivity is:

S_{A/W}=(C_{A}/C_{W})org/(C_{A}/C_{W})aq

where (C_{A}/C_{W})aq is the ratio between acid concentration and water concentration in the aqueous phase and (C_{A}/C_{W})org is that ratio in the organic phase. According to an embodiment, when determined at C_{A} aqueous concentration of 1 molar, S_{A/W} of the first extractant is greater than that of the second extractant by at least 10%, preferably at least 30% and more preferably at least 50%.

Similarly, selectivity to acid over a salt (S_{A/S}) can be determined by equilibrating a salt-comprising aqueous acid solution with an extractant and analyzing the concentrations of the acid and the salt in the equilibrated phases. In that case, the selectivity is:

S_{A/C}=(C_{A}/C_{S})org/(C_{A}/C_{S})aq.

According to an embodiment, when determined at C_{A} aqueous concentration of 1 molar and Cₛ aqueous concentration of 1 molar, S_{A/S} of the first extractant is greater than that of the second extractant by at least 10%, preferably at least 30% and more preferably at least 50%.

According to an embodiment, the acid/water ratio in the first extract is greater than that ratio in the organic phase composition of step (iii) by at least 10%, preferably at least 30% and more preferably at least 50%.

According to another embodiment, the acid/salt ratio in the first extract is greater than that ratio in the organic phase composition of step (iii) by at least 10%, preferably at least 30% and more preferably at least 50%.

The distribution coefficient of acid extraction (D_{A}) can be determined by equilibrating an aqueous Acid solution with an extractant and analyzing the concentrations of the acid in the equilibrated phases. In that case, the distribution coefficient is:

D_{A}=Corg/Caq

where Corg and Caq are acid concentrations in the organic and aqueous phases, respectively. According to an embodiment, when determined at Caq of 1 molar, D_{A} of the second extractant is greater than that of the first extractant by at least 10%, preferably at least 30% and more preferably at least 50%.

According to an embodiment the method for the separation of the separation of acid from a salt uses a system comprising two extraction units and a distillation unit, as shown in the FIGURE. The aqueous feed is extracted first in Solvent Extraction #1 to form the acid-depleted aqueous feed, which is then extracted in Solvent Extraction #2 to form the further acid-depleted aqueous feed. The second extractant extracts first acid from the acid-depleted aqueous feed in Solvent Extraction #2 to form the organic phase composition. That composition is treated in Distillation to remove at least part of the S2 in it and to form the first extractant. The latter is then used to extract acid from the aqueous feed in Solvent Extraction #1 and to form the acid-carrying first extract.

The method of the present invention preferably comprises a step of acid recovery from the acid-carrying first extract. According to an embodiment, recovering comprises back-extraction with water or with an aqueous solution to form an aqueous solution of the acid and a regenerated extractant. According to an embodiment, acid recovery comprises removal of S1, S2 or both, for example by distillation. According to an embodiment, distillation of S1 used azeotropic distillation with water. If needed, water or an aqueous solution is added for such azeotropic distillation. According to still another embodiment, recovery comprises the addition of another solvent, S3. According to an embodiment, S3 is characterized by water solubility smaller than that of S1. According to another embodiment, S3 is characterized by a delta-P smaller than that of S1 by at least by at least 0.2 MPa^{1/2}, preferably by at least 0.4 MPa^{1/2} and more preferably by at least 0.6 MPa^{1/2}. According to another embodiment, S3 is characterized by a delta-H smaller than that of S1 by at least by at least 0.2 MPa^{1/2}, preferably at least 0.4 MPa^{1/2} and more preferably by at least 0.6 MPa^{1/2}. According to an embodiment, said non-volatile strong acid is sulfuric acid and said step of acid recovery comprises contacting said first extract with sulfur trioxide. According to a related embodiment, upon such contacting a concentrated solution of sulfuric acid separates from said first extract.

Recovery of the acid from the first acid-carrying first extract regenerates S1 to form regenerated S1. Said regenerated S1 is used according to an embodiment for forming said second extractant. According to an embodiment, forming said second extract comprises combining the regenerated S1 with S2. Preferably combining is with S2 separated from the organic phase composition during the formation of the first extractant. According to an embodiment, said recovered S1 is divided into two fractions, one of which is combined with S2 to reform the second extractant, while the other is combined with the first extractant.

According to still another embodiment, the provided aqueous feed comprises an impurity, the impurity/salt ratio in said feed is R1, the impurity/salt ratio in the further depleted aqueous feed is R2 and the R1/R2 ratio is greater than 1.5. According to an embodiment, said impurity is another acid, e.g. phosphoric acid. According to another embodiment, said impurity is another salt, e.g. iron chloride.

While the invention will now be described in connection with certain preferred embodiments in the following examples so that aspects thereof may be more fully understood and appreciated, it is not intended to limit the invention to these particular embodiments. On the contrary, it is intended to cover all alternatives, modifications and equivalents as may be included within the scope of the invention as defined by the appended claims. Thus, the following examples which include preferred embodiments will serve to illustrate the practice of this invention, it being understood that the particulars shown are by way of example and for purposes of illustrative discussion of preferred embodiments of the present invention only and are presented in the cause of providing what is believed to be the most useful and readily understood description of formulation procedures as well as of the principles and conceptual aspects of the invention.

### EXAMPLES

### Example No 1

10 grams of a solution containing H₂SO₄ and various salts and 5 grams of solvent were introduced into vials. The vials were shaken at 27° C. The composition of the 2 phases obtained after settling is presented in Table 1.

TABLE 1
The solvent is Hexanol

| Solvent phase composition | | | | | Aqueous phase composition | | | | |
|---|---|---|---|---|---|---|---|---|---|
| H₂SO₄ | Ti | Fe+3 | Fe+2 | Zn | H₂SO₄ | Ti | Fe+3 | Fe+2 | Zn |
| Wt % | Wt % | Wt % | Wt % | Wt % | Wt % | Wt % | Wt % | Wt % | Wt % |
| 7.86 | 0.011 | <0.0029 | ND | ND | 32.81 | 0.61 | 0.91 | 0.70 | 1.20 |
| 0.73 | 0.0039 | <0.0033 | ND | ND | 18.22 | 0.78 | 1.04 | 0.80 | 1.36 |
| 0.25 | 0.0014 | ND | ND | ND | 13.46 | 0.83 | 1.08 | 0.83 | 1.41 |

Table 1a describes Solvent/aqueous distribution and H₂SO₄/cation selectivity values obtained.

TABLE 1a

| | H₂SO₄ | Ti | Selectivity |
|---|---|---|---|
| | Distribution of | Distribution | Solvent/aqueous |
| Solvent | H₂SO₄ | of titanium | H₂SO₄/Ti |
| Hexanol | 0.240 | 0.018 | 13.27 |
| Hexanol | 0.040 | 0.005 | 7.96 |
| Hexanol | 0.019 | 0.002 | 11.04 |

Table 2 describes the composition when the solvent is Hexanol:Ethanol at 1.5:1 ratio.

TABLE 2

| Solvent phase composition | | | | | Aqueous phase composition | | | | |
|---|---|---|---|---|---|---|---|---|---|
| H₂SO₄ | Ti (IV) | Fe⁺³ | Fe⁺² | Zn | H₂SO₄ | Ti | Fe⁺³ | Fe⁺² | Zn |
| Wt % | Wt % | Wt % | Wt % | Wt % | Wt % | Wt % | Wt % | Wt % | Wt % |
| 13.04 | 0.048 | 0.083 | | 0.03 | 29.0 | 0.61 | 0.91 | 0.70 | 1.20 |
| 0.44 | 0.001 | 0.0085 | ND | ND | 8.6 | 0.78 | 1.04 | 0.80 | 1.37 |
| 0.91 | ND | ND | ND | ND | 11.0 | 0.84 | 1.08 | 0.83 | 1.42 |

Table 2a describes Solvent/aqueous distribution and H₂SO₄/cation selectivity values obtained for the same.

TABLE 2a

| | | Ti | Fe⁺³ | Zn | | | |
|---|---|---|---|---|---|---|---|
| | H₂SO₄ | Distribution | Distribution | Distribution | Selectivity | H₂SO₄/ | Selectivity |
| Solvent | Distribution | of Ti(IV) | of Fe(3+) | of Zn | H₂SO₄/Ti | Fe+3 | H₂SO₄/Zn |
| Hexanol/ | 0.449 | 0.079 | 0.037 | 0.025 | 5.71 | 12.0 | 18.2 |
| Ethanol | | | | | | | |
| Hexanol/ | 0.051 | 0.001 | 0.0031 | | 76.5 | 16.3 | |
| Ethanol | | | | | | | |
| Hexanol/ | 0.083 | 0.000 | | | | | |
| Ethanol | | | | | | | |

Table 3 describes the composition when the solvent is Pentanol (Vial 1) or 30% Ethanol in (Ethanol+Pentanol) (Vial 2).

TABLE 3

| Light phase composition | | | | | Heavy phase composition | | | | |
|---|---|---|---|---|---|---|---|---|---|
| H₂SO₄ | Ti | Fe+3 | Fe+2 | Zn | H₂SO₄ | Ti | Fe⁺³ | Fe⁺² | Zn |
| Wt % | Wt % | Wt % | Wt % | Wt % | Wt % | Wt % | Wt % | Wt % | Wt % |
| 11.05 | 0.023 | 0.027 | 0.025 | 0.0023 | 32.4 | 0.61 | 0.91 | 0.70 | 1.20 |
| 16.45 | 0.122 | 0.14 | 0.176 | 0.0047 | 29.4 | 0.64 | 0.94 | 0.72 | 1.24 |

Tables 3b and 3c describe solvent/aqueous distribution and H₂SO₄/cation selectivity values obtained for the same.

TABLE 3b

| | | | Distri- | Distribution | |
|---|---|---|---|---|---|
| Vial | Distribution | Distribution | bution | of | Distribution |
| No | of H₂SO₄ | of Ti(IV) | of Fe⁺³ | Ti(IV) Fe²⁺ | of Zn |
| 1 | 0.341 | 0.037 | 0.029 | 0.036 | 0.0019 |
| 2 | 0.560 | 0.189 | 0.146 | 0.24 | 0.0038 |

TABLE 3C

| Vial | Selectivity | Selectivity | Selectivity | Selectivity |
|---|---|---|---|---|
| No | H₂SO₄/Ti | H₂SO₄/Fe⁺³ | H₂SO₄/Fe⁺² | H₂SO₄/Zn |
| 1 | 9.2 | 11.6 | 9.5 | 177.4 |
| 2 | 3.0 | 3.8 | 2.3 | 148.0 |

These results indicate that in all cases, the distribution of the sulfuric acid into the solvent phase is increased if the polar solvent ethanol is added to the less polar solvent. On the other hand, for all metal cations that were tested, the H₂SO₄/Cation selectivity dramatically decreases when the polar solvent is added to the less polar solvent

### Example No 2

100 grams of an aqueous phase containing 40% H₂SO₄, 1.5% Ti (as TiOSO₄), 2% Fe³⁺ (as Fe₂(SO₄)₃, 1.5% Fe2+(as FeSO₄) and 2.5% Zn (as ZnSO₄) were flowed through a 2 stage counter current unit. 600 grams of Pentanol were flowed through the other end (Flow rates of 2:1). The compositions of the phases exiting the unit at the end of the experiment were analyzed.

Table 4 describes the composition of the two phases exiting the unit.

TABLE 4

| | H₂SO₄ | | | | |
|---|---|---|---|---|---|
| | Wt % | Ti (IV) | Fe³⁺ | Fe²⁺ | Zn |
| Solvent phase | 6 | 0.056 | 0.058 | 0.054 | 0.0048 |
| Aqueous phase | 6.18 | 1.5 | 2 | 1.5 | 2.5 |
| In solvent (wt % of | 86.4 | 0.33 | 0.35 | 0.32 | 0.03 |
| initial) | | | | | |
| Remaining in aqueous | | 99.7 | 99.7 | 99.7 | 100.0 |
| (wt % of initial) | | | | | |

### Example 3

100 grams of an aqueous phase containing 40% H₂SO₄, 1.5% Ti (as TiOSO₄), 2% Fe³⁺ (as Fe₂(SO₄)₃, 1.5% Fe2+(as FeSO₄) and 2.5% Zn (as ZnSO₄) were flowed through a 2 stage counter current unit. 857 grams of a solvent containing 30 (wt % of solvent) ethanol in Pentanol were flowed through the other end (Flow rates of 2:1). The compositions of the phases exiting the unit at the end of the experiment were analyzed and the results are presented in Table 5.

TABLE 5

| | H₂SO₄ | | | | |
|---|---|---|---|---|---|
| | Wt % | Ti (IV) | Fe³⁺ | Fe²⁺ | Zn |
| Solvent phase | 4.72 | 0.28 | 0.29 | 0.360 | 0.010 |
| Aqueous phase | 2.4 | 1.5 | 2 | 1.5 | 2.5 |
| In solvent (wt % of initial) | 94.3 | 2.43 | 2.50 | 3.09 | 0.08 |
| Remaining in aqueous | | 97.6 | 97.5 | 96.9 | 99.9 |
| (wt % of initial) | | | | | |

### Example 4

100 grams of an aqueous phase containing 40% H₂SO₄, 1.5% Ti (as TiOSO₄), 2% Fe³⁺ (as Fe₂(SO₄)₃, 1.5% Fe2+(as FeSO₄) and 2.5% Zn (as ZnSO₄) were flowed through a 2 stage counter current unit. 857 grams of a solvent containing 257 grams of ethanol and 600 grams of pentanol were flowed through the other end (Flow rates of 2:1). After the first extraction, the solvent phase was removed and the ethanol present in it was evaporated. The free-of-ethanol solvent was than returned to the second extraction stage. The compositions of the phases exiting the unit at the end of the experiment were analyzed and the results are provided in Table 6.

TABLE 6

| | H₂SO₄ | | | | |
|---|---|---|---|---|---|
| | Wt % | Ti (IV) | Fe³⁺ | Fe²⁺ | Zn |
| Solvent phase | 6.5 | 0.057 | 0.059 | 0.0555 | 0.0048 |
| Aqueous phase | 3.27 | 1.5 | 2 | 1.5 | 2.5 |
| In solvent (wt % of | | 0.33 | 0.35 | 0.32 | 0.03 |
| initial) | | | | | |
| Remaining in aqueous | 90.9 | 99.7 | 99.7 | 99.7 | 100.0 |
| (wt % of initial) | | | | | |

It will be evident to those skilled in the art that the invention is not limited to the details of the foregoing illustrative examples and that the present invention may be embodied in other specific forms without departing from the essential attributes thereof, and it is therefore desired that the present embodiments and examples be considered in all respects as illustrative and not restrictive, reference being made to the appended claims, rather than to the foregoing description, and all changes which come within the meaning and range of equivalency of the claims are therefore intended to be embraced therein.

It will be understood by those skilled in the art that various changes in form and details may be made herein without departing from the spirit and scope of the invention as set forth in the appended claims. Those skilled in the art will recognize, or be able to ascertain using no more than routine experimentation, many equivalents to the specific embodiments of the invention described herein. Such equivalents are intended to be encompassed in the scope of the claims. In the claims articles such as “a,”, “an” and “the” mean one or more than one unless indicated to the contrary or otherwise evident from the context. Claims or descriptions that include “or” or “and/or” between members of a group are considered satisfied if one, more than one, or all of the group members are present in, employed in, or otherwise relevant to a given product or process unless indicated to the contrary or otherwise evident from the context. The invention includes embodiments in which exactly one member of the group is present in, employed in, or otherwise relevant to a given product or process. The invention also includes embodiments in which more than one, or all of the group members are present in, employed in, or otherwise relevant to a given product or process. Furthermore, it is to be understood that the invention provides, in various embodiments, all variations, combinations, and permutations in which one or more limitations, elements, clauses, descriptive terms, etc., from one or more of the listed claims is introduced into another claim dependent on the same base claim unless otherwise indicated or unless it would be evident to one of ordinary skill in the art that a contradiction or inconsistency would arise. Where elements are presented as lists, e.g., in Markush group format or the like, it is to be understood that each subgroup of the elements is also disclosed, and any element(s) can be removed from the group. It should it be understood that, in general, where the invention, or aspects of the invention, is/are referred to as comprising particular elements, features, etc., certain embodiments of the invention or aspects of the invention consist, or consist essentially of, such elements, features, etc. For purposes of simplicity those embodiments have not in every case been specifically set forth in haec verba herein. Certain claims are presented in dependent form for the sake of convenience, but Applicant reserves the right to rewrite any dependent claim in independent format to include the elements or limitations of the independent claim and any other claim(s) on which such claim depends, and such rewritten claim is to be considered equivalent in all respects to the dependent claim in whatever form it is in (either amended or unamended) prior to being rewritten in independent format.

1. An organic phase composition comprising
(a) a first solvent (S1) characterized by water solubility of less than 10% and by at least one of (a1) having a polarity related component of Hoy's cohesion parameter (delta-P) between 5 and 10 MPa^{1/2} and (b1) having a Hydrogen bonding related component of Hoy's cohesion parameter (delta-H) between 5 and 20 MPa^{1/2};
(b) a second solvent (S2) characterized by a water solubility of at least 30% and by at least one of (a2) having delta-P greater than 8 MPa^{1/2} and (b2) having delta-H greater than 12 MPa^{1/2};
(c) water;
(d) a non-volatile strong acid; and
(e) a salt thereof.

2. The composition according to claim 1, wherein S2 is selected from the group consisting of C1-C4 mono- or poly-alcohols, aldehydes and ketones.

3. The composition according to claim 1, wherein S1 is selected from the group consisting of alcohols, ketones and aldehydes having at least 5 carbon atoms.

4. The composition according to claim 1, wherein said non-volatile strong acid is selected from the group consisting of sulfuric acid, phosphoric acid and nitric acid.

5. The composition according to claim 1, wherein said salt is selected from the group consisting of salts of calcium and of heavy metals.

6. The composition according to claim 1, wherein the weight/weight ratio of S1/S2 is in the range between 10 and 0.5.

7. The composition according to claim 1, wherein the weight/weight ratio of acid/water is greater than 0.15.

8. The composition according to claim 1, wherein the weight/weight ratio of acid/salt is greater than 10.

9. The composition according to claim 1, wherein salt concentration is in a range between 0.01% wt and 5% wt.

10. The composition according to claim 1, wherein S1 forms a heterogeneous azeotrope with water, wherein S2 forms a homogeneous azeotrope with water, or both.

11. A method for the separation of a non-volatile strong acid from a salt thereof comprising:
(i) providing an aqueous feed solution comprising a non-volatile strong acid and a salt thereof;
(ii) bringing said aqueous feed solution into contact with a first extractant comprising a first solvent S1 characterized by a water solubility of less than 10% and by at least one of (a1) having a delta-P between 5 and 10 MPa^{1/2} and (b1) having a delta-H between 5 and 20 MPa^{1/2}, whereupon acid selectively transfers to said first extractant to form an acid-carrying first extract and an acid-depleted aqueous feed;
(iii) bringing said acid-depleted aqueous feed solution into contact with a second extractant comprising S1 and a second solvent S2 characterized by water solubility of at least 30% and by at least one of (a2) having a delta-P greater than 8 MPa^{1/2} and (b2) having a delta-H greater than 12 MPa^{1/2}, whereupon acid selectively transfers to said second extractant to form an organic composition according to claim 1 and a further acid-depleted aqueous feed; and
(iv) recovering acid from said first extract.

12. The method according to claim 11, wherein said aqueous feed is a product of leaching a mineral with a non-volatile strong acid.

13. The method according to claim 12, wherein said mineral is rich in titanium.

14. The method according to claim 12, wherein said mineral is rich in phosphate.

15. The method according to claim 11, wherein at least one of said bringing in contact of step (ii) and said bringing in contact of step (iii) comprises multiple stage counter-current contacting.

16. The method according to claim 11, wherein S2 is selected from the group consisting of C₁-C₄ mono- or poly-alcohols, aldehydes and ketones.

17. The method according to claim 11, wherein S1 is selected from the group consisting of alcohols, ketones and aldehydes having at least 5 carbon atoms.

18. The method according to claim 11, wherein delta-P of said second extractant is greater than delta-P of said first extractant by at least 0.2 MPa^{1/2}.

19. The method according to claim 11, wherein said delta-H of said second extractant is greater than delta-P of said second extractant by at least 0.2 MPa^{1/2}.

20. The method according to claim 11, wherein said first extractant comprises S2 and wherein S2/S1 ratio in said second extractant is greater than S2/S1 ratio in said first extractant by at least 10%.

21. The method according to claim 20, wherein the first extractant is generated from the organic composition formed in step (iii) by removing S2 therefrom.

22. The method according to claim 11 further comprising a step of removing S2 from the organic composition formed in step (iii), whereupon said first extract is formed.

23. The method according to claim 22, whereupon on said removing of S2 a heavy aqueous phase is formed and said heavy phase is separated from said formed first extract.

24. The method according to claim 23, wherein the acid/water ratio in said heavy phase is smaller than that ratio in the acid-depleted aqueous feed.

25. The method according to claim 23, wherein the acid/salt ratio in said heavy phase is smaller than that ratio in the acid-depleted aqueous feed.

26. The method according to claim 11, wherein the acid/water ratio in said first extract is greater than that ratio in the organic composition of step (iii) by at least 10%.

27. The method according to claim 11, wherein the acid/water ratio in said first extract is greater than that ratio in the aqueous feed by at least 10%.

28. The method according to claim 11, wherein the acid/salt ratio in said first extract is greater than that ratio in the organic composition of step (iii) by at least 10%.

29. The method according to claim 11, wherein said recovering comprises at least one of acid back-extraction with water or an aqueous solution, removal of S1, S2 or both and addition of a solvent S3, which solvent is characterized by water solubility smaller than that of S1.

30. The method according to claim 11, said non-volatile strong acid is sulfuric acid and said step of acid recovery comprises contacting said first extract with sulfur trioxide.

31. The method according to claim 11, wherein the acid/salt ratio in said further depleted aqueous feed is smaller than 0.05.

32. The method according to claim 11, wherein said provided aqueous feed comprises an impurity, wherein the impurity/salt ratio in said feed is R1, wherein the impurity/salt ratio in said further depleted aqueous feed is R2 and wherein R1/R2 is greater than 1.5.

33. The method according to claim 32 wherein said impurity is another acid.

34. The method according to claim 32 wherein said impurity is another salt.
